(19) United States
(12) Patent Application Publication
(10) Pub. No.: US 2026/0174539 A1
(43) Pub. Date: Jun. 25, 2026

(54) ORAL NURSING DEVICE AND FLUID PUMPING ASSEMBLY FOR ORAL CLEANING

(71) Applicant: Shenzhen Soocas Technology Co., Ltd., Shenzhen (CN)

(72) Inventor: Sanlian QIN, Shenzhen (CN)

(73) Assignee: Shenzhen Soocas Technology Co., Ltd., Shenzhen (CN)

(21) Appl. No.: 19/428,310

(22) Filed: Dec. 22, 2025

Related U.S. Application Data
(63) Continuation of application No. PCT/CN2025/118374, filed on Sep. 2, 2025.

(30) Foreign Application Priority Data
Dec. 25, 2024 (CN) 2024119602069

(51) Int. Cl. A61C 17/22; A46B 13/04; A61C 17/028; F04B 19/04; F04B 39/00; F16H 37/12

(52) U.S. Cl. CPC A61C 17/227; A46B 13/04; A61C 17/028; F04B 19/04; F04B 39/0005; F16H 37/124

(57) ABSTRACT

The present application discloses an oral nursing device and a fluid pumping assembly for oral cleaning. The oral nursing device at least includes a main housing, a housing component, a fluid bumping component, an electronic device and a driving unit, wherein the main housing has an outer wall and a body chamber defined by the outer wall; the housing component is arranged in the body chamber and divides the body chamber into at least a first space and a second space which are hermetically isolated from each other; the fluid pumping component is assembled in the first space, and the fluid pumping component is in communication with a fluid source through a flow guide channel; and the electronic device and the driving unit are assembled in the second space, and the driving unit drives the fluid pumping component to run.

### CROSS REFERENCE TO RELATED APPLICATION

The present application is a continuation of International Application No. PCT/CN 2025/118374, filed on Sep. 2, 2025, which claims priority to Chinese patent application No. 2024119602069, entitled “Oral Nursing Device and Fluid Pumping Assembly for Oral Cleaning”, filed on Dec. 25, 2024, the entire content of which is incorporated herein by reference.

### TECHNICAL FIELD

The present application relates to the field of oral nursing technologies, and in particular, to an oral nursing device and a fluid pumping assembly for oral cleaning.

### BACKGROUND

An oral nursing device with an oral irrigation function is typically provided with a pump and draws liquid from a water tank through the pump to output water flow that impacts the oral cavity of a user for oral cleaning.

However, during use of the pump, water vapor may leak out to increase air humidity, and even liquid leakage may exist, which may cause corrosion and damage to electronic devices in the oral nursing device, such as a battery and a circuit board.

### SUMMARY

An object of the present application is to provide an oral nursing device and a fluid pumping assembly for oral cleaning.

In order to achieve the above object, in an aspect, the present application provides an oral nursing device at least including:
a main housing having an outer wall and a body chamber defined by the outer wall;
a housing component arranged in the body chamber and dividing the body chamber into at least a first space and a second space which are hermetically isolated from each other;
a fluid pumping component assembled in the first space, the fluid pumping component being in communication with a fluid source through a flow guide channel; and
an electronic device and a driving unit assembled in the second space, the driving unit driving the fluid pumping component to run to draw fluid in the fluid source through the flow guide channel and output a water flow impact.

Optionally, the housing component includes a divider, and the divider is coupled with an inner wall surface of the main housing to divide the body chamber into the first space and the second space.

Optionally, the housing component includes a divider and a first shell part, and the divider and the first shell part define the second space.

Optionally, an interface of the divider and the first shell part is provided with a first sealing part.

Optionally, one of the divider and the first shell part is formed integrally with the first sealing part by means of dual-injection molding, and the other is in interference fit with the first sealing part.

Optionally, the divider or the first shell part is provided with a first avoiding hole, an output end of the driving unit passes through the first avoiding hole to extend to the first space, and a second sealing part is packed between the output end and the first avoiding hole.

Optionally, a key hole is arranged in the first shell part; the electronic device includes a PCB, the housing component further includes a key sealing part coupled with the PCB, and the key sealing part seals the key hole.

Optionally, an outer surface defined by the divider and the first shell part and the main housing define the first space.

Optionally, the housing component further includes a second shell part located within the first space; the second shell part is coupled with the divider to divide the first space into a third space and a fourth space, the third space is defined by the divider and the second shell part, and the fluid pumping component is assembled in the third space.

Optionally, the fourth space is defined by the main housing and an outer surface defined by the divider, the first shell part and the second shell part, and the flow guide channel is at least partially located in the fourth space.

Optionally, the fourth space is arranged around the second space, and/or the fourth space is arranged around the third space.

Optionally, a third sealing part is arranged at an interface of the divider and the second shell part.

Optionally, the fluid pumping component includes an execution unit and a transmission unit, the execution unit includes a pump body and a piston, the pump body has a first inlet and a first outlet, and the piston is slidably arranged in the pump body.

Optionally, the transmission unit includes a first gear, an end surface eccentric gear and a connecting rod; the first gear is connected with the output end of the driving unit and meshed with a gear portion of the end surface eccentric gear; one end of the connecting rod is connected with an eccentric portion of the end surface eccentric gear, the other end of the connecting rod is connected with the piston, and the first gear, the eccentric portion of the end surface eccentric gear and the connecting rod are located on the same side of the gear portion of the end surface eccentric gear.

Optionally, the main housing has a main extension line; the driving unit, the transmission unit and the execution unit are arranged along the main extension line, and the electronic device and the fluid pumping component are arranged along a direction perpendicular to the main extension line.

Optionally, the housing component includes a divider and a second shell part; the divider and the second shell part define the first space, and an outer surface defined by the divider and the second shell part and the main housing define the second space.

Optionally, the oral nursing device further includes a liquid guide connector and a nozzle head, wherein the first inlet of the fluid pumping component is in communication with the fluid source through the flow guide channel, and the first outlet of the fluid pumping component is in communication with the nozzle head through the liquid guide connector.

Optionally, the oral nursing device further includes a brush head and a motor, wherein the motor has a power output shaft, the motor drives the brush head to perform a cleaning motion through the power output shaft, the power output shaft is a hollow shaft, and the first outlet of the fluid pumping component is communicated with a conveying flow channel in the brush head through the power output shaft.

Based on the same inventive concept, the present application further provides a fluid pumping assembly for oral cleaning, including: a divider, a first shell part, a second shell part, a fluid pumping component, an electronic device and a driving unit, wherein the first shell part and the second shell part are located on two opposite sides of the divider respectively, the first shell part and the divider define a third space, the second shell part and the divider define a first space, the fluid pumping component is assembled in the first space, and the electronic device and the driving unit are assembled in the third space.

### BRIEF DESCRIPTION OF THE DRAWINGS

To describe the technical solutions of the embodiments of the present application more clearly, the following briefly describes the accompanying drawings required for describing the embodiments. Apparently, the accompanying drawings in the following description only show some embodiments of the present application, and a person of ordinary skill in the art may still derive other drawings from these accompanying drawings without creative efforts.

FIG. 1 is a schematic semi-sectional diagram of an oral nursing device according to an embodiment of the present application;

FIG. 2 is a schematic semi-sectional diagram of the oral nursing device according to another embodiment of the present application;

FIG. 3 is a schematic semi-sectional diagram of the oral nursing device according to still another embodiment of the present application;

FIG. 4 is a schematic semi-sectional diagram of the oral nursing device according to yet another embodiment of the present application;

FIG. 5 is a schematic semi-sectional diagram of a fluid pumping assembly according to another embodiment of the present application;

FIG. 6 is a schematic exploded diagram of a part of a structure of the fluid pumping assembly according to another embodiment of the present application;

FIG. 7 is a schematic semi-sectional diagram of FIG. 6;

FIG. 8 is a schematic exploded diagram of the fluid pumping assembly according to another embodiment of the present application;

FIG. 9 is a schematic semi-sectional diagram of FIG. 8; and

FIG. 10 is a schematic exploded semi-sectional diagram of another part of the structure of the fluid pumping assembly according to another embodiment of the present application.

### REFERENCE NUMERALS

100: main housing; 110: body chamber; 111: first space; 112: second space; 113: third space; 114: fourth space;
200: housing component; 210: divider; 2141: avoiding hole; 220: first shell part; 221: key hole; 230: second shell part; 240: first sealing part; 250: second sealing part; 260: key sealing part;
300: fluid pumping component; 310: execution unit; 311: pump body; 3111: first inlet; 3112: first outlet; 312: piston; 320: transmission unit; 321: first gear; 322: end surface eccentric gear; 323: connecting rod;
400: electronic device; 410: PCB; 420: battery;
500: driving unit;
600: flow guide channel; 610: liquid guide connector;
700: fluid source;
800: nozzle head;
a: main extension line.

### DETAILED DESCRIPTION

Current oral nursing devices on the market achieve an oral irrigation function mainly with three designs. The first design is a design combining an oral irrigator and a liquid supply base station, and the liquid supply base station is provided therein with a pump which is responsible for delivering water flow to the oral irrigator to generate a water flow impact. As the second design, an oral irrigator is integrated with a pump, so that the device can independently provide a water flow impact without an additional liquid supply base station. The third design is an irrigation-brushing all-in-one machine which not only integrates the irrigation function, but also has a tooth brushing function, and a pump is also integrated inside the irrigation-brushing all-in-one machine to provide a required water flow impact. These designs have their own unique characteristics to meet requirements and use scenarios of different users, but all need the pump to provide the water flow impact.

However, usual water pumps, such as piston pumps, plunger pumps and diaphragm pumps, draw liquid mainly through a stroke and squeeze the liquid into an output pipe, which may lead to moisture leakage in this process. Taking the piston pump as an example, after in-depth study, the applicant found that a cylinder sleeve is arranged in the pump, a piston extends and retracts in the cylinder sleeve in a reciprocating manner to suck and discharge the liquid, the liquid can be attached to an inner wall of the cylinder sleeve in this process, and water vapor formed after evaporation enters a transmission cavity and then is emitted to a motor and outwards from the transmission cavity, so that the motor is damaged, and electronic parts and components, such as a battery and a circuit board, in the oral nursing device are corroded and damaged. With long-term running of the piston, a sealing ring between the piston and the cylinder sleeve may also be damaged or deformed to cause liquid leakage, which may also damage the motor and corrode and damage the electronic parts and components, such as the battery and the circuit board, in the oral nursing device.

The applicant tried to mount two sealing rings on the piston to improve a sealing performance between the piston and the inner wall of the cylinder sleeve by increasing a number of the sealing rings, so as to avoid water leakage. But this solution also increases a frictional force between the piston and the cylinder sleeve correspondingly, needs a bigger power driving piston, and still cannot avoid that the liquid is attached to the inner wall of the cylinder sleeve to evaporate and leak.

The applicant also tried to provide an accordion-folded sealing sleeve between an outer wall surface of the cylinder sleeve or an outer wall surface of a pump body and a connecting rod for driving the piston to move, and the sealing sleeve is used to isolate the liquid attached to the inner wall of the cylinder sleeve from the outside, so as to avoid that the liquid attached to the inner wall of the cylinder sleeve is diffused outwards after being evaporated. Although this solution can prevent leakage of the liquid and moisture, since the sealing sleeve needs to move along with the connecting rod, the sealing sleeve is quite prone to be damaged and aged, a service life is low, and leakage may also be generated after damaging and aging to damage the electronic parts and components.

Therefore, the applicant finally divides a body chamber defined by a main housing of the oral nursing device into a first space and a second space which are hermetically isolated, places a fluid pumping component generating moist fluid in the first space, and places a driving unit and an electronic device which are easily damaged by the moist fluid in the second space, thereby realizing dry-wet separation, reducing the possibility of damage to the electronic device in the oral nursing device caused by leakage of the moist fluid and prolonging a service life of the oral nursing device.

To make the objectives, technical solutions and advantages of the embodiments of the present application clearer, the technical solutions in the embodiments of the present application are clearly and completely described with reference to the accompanying drawings in the embodiments of the present application, and apparently, the described embodiments are not all but a part of the embodiments of the present application.

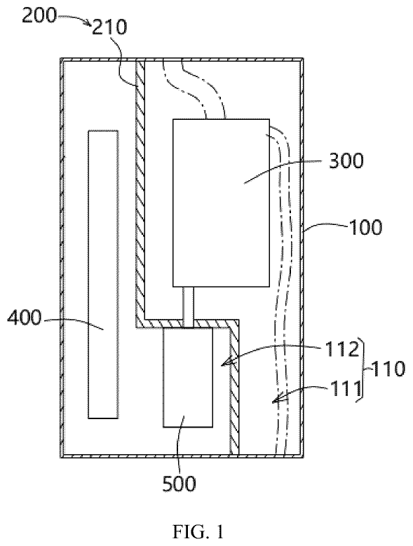

Referring to FIGS. 1 to 5 together, in an implementable embodiment, an oral nursing device can include at least a main housing 100, a housing component 200, a fluid pumping component 300, an electronic device 400, and a driving unit 500. The main housing 100 serves as a carrying component of the oral nursing device, and is mainly configured to support and protect remaining parts in the oral nursing device. Specifically, the main housing 100 has an outer wall and a body chamber 110 defined by the outer wall, the housing component 200 is arranged in the body chamber 110, and the body chamber 110 is divided by the housing component 200 into at least a first space 111 and a second space 112 which are hermetically isolated from each other. The fluid pumping component 300 is assembled in the first space 111, and the fluid pumping component 300 is communicated with a fluid source 700 through a flow guide channel 600. The electronic device 400 and the driving unit 500 are assembled in the second space 112, and the driving unit 500 drives the fluid pumping component 300 to operate, thereby drawing fluid in the fluid source 700 through the flow guide channel 600 and outputting a water flow impact.

That is, in the present application, the fluid pumping component 300 which may leak moist fluid and the electronic device 400 and the driving unit 500 which are easily damaged by the moist fluid are mounted in the two spaces hermetically isolated from each other respectively, so that even when the fluid pumping component 300 leaks the moist fluid, it is also avoided that the moist fluid enters the second space 112 through the first space 111 to damage the electronic device 400 and the driving unit 500.

In practical applications, the main housing 100 may be formed by splicing an upper cover and a housing, or by splicing an upper cover, a lower cover and a housing, which is not particularly limited in the present application. Splicing positions of the main housing 100 should be provided with waterproof structures to avoid that external moist fluid enters the body chamber 110 to damage the electronic device 400 and the driving unit 500 in the body chamber 110.

The fluid pumping component 300 may be a diaphragm pump, a plunger pump, a piston pump, or the like, the driving unit 500 may be an air cylinder, a motor, or the like, but considering that the motor has high controllability and an electric control structure is simple and easy to implement, the driving unit 500 is preferred to be a motor in the present application.

The electronic device 400 may be one or more of a PCB 410, a battery 420, a button assembly, or the like.

The fluid source 700 may be a part of the oral nursing device, the fluid source 700 may be connected with the main housing 100 to form a structure similar to an integrated oral irrigator, and correspondingly, a waterproof structure should be provided between the fluid source 700 and the main housing 100 to prevent the liquid in the fluid source 700 from directly leaking into the body chamber 110. The fluid source 700 may be separated from the main housing 100, the fluid source 700 may be connected with the main housing 100 through a hose, and at this point, the fluid source may be a water supply component, such as an external water tank. Certainly, the fluid source 700 may not be a part of the oral nursing device, and the fluid source 700 may be a water supply component, such as a faucet.

Leakage may occur at a joint between the flow guide channel 600 and the fluid pumping component 300, and when a sealing effect of the body chamber 110 is poor, moisture in an external environment may easily condense to form water drops on an outer wall surface of the flow guide channel 600 to form the moist fluid. Therefore, at least a part of the flow guide channel 600 may be arranged in the first space 111, so that the possibility that the leakage generated by the flow guide channel 600 damages the driving unit 500 and the electronic device 400 inside the oral nursing device may be avoided, and the service life of the oral nursing device may be prolonged.

For a specific manner in which the housing component 200 divides the body chamber 110 into the first space 111 and the second space 112, three realizable embodiments are provided for reference in the present application.

First embodiment: as shown in FIG. 1, the housing component 200 may include a divider 210, and the divider 210 is coupled with an inner wall surface of the main housing 100 to divide the body chamber 110 into the first space 111 and the second space 112.

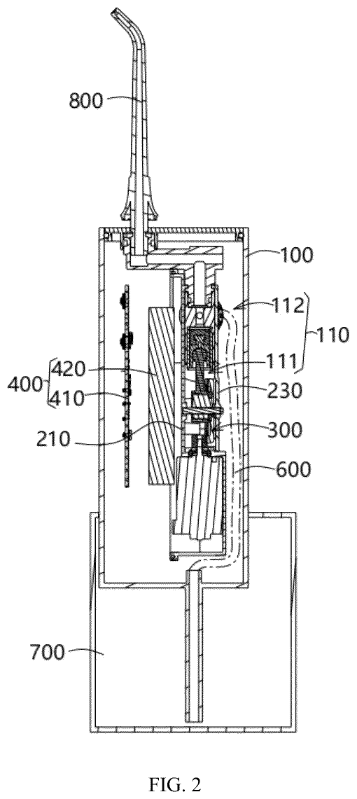

Second embodiment: as shown in FIG. 2, the housing component 200 may include a divider 210 and a second shell part 230, the divider 210 and the second shell part 230 define the first space 111, and an outer surface defined by the divider 210 and the second shell part 230 and the main housing 100 define the second space 112.

The divider 210 or the second shell part 230 may be further coupled with an inner wall surface of the main housing 100 to further divide the second space 112 into a plurality of spaces. Or, a second divider is further arranged inside the body chamber 110, and the second divider is coupled with an inner wall surface of the body chamber 110 to further divide the second space 112 into a plurality of spaces.

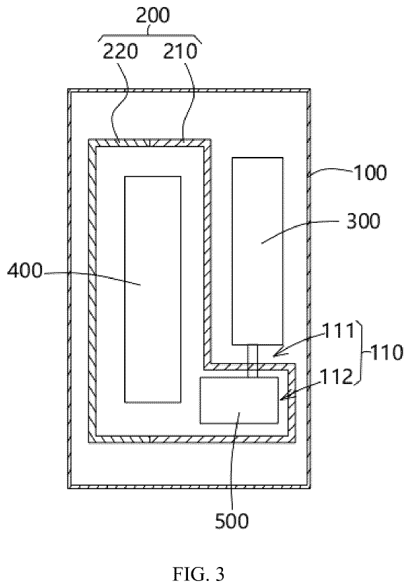

Third embodiment: as shown in FIG. 3, the housing component 200 includes a divider 210 and a first shell part 220, and the divider 210 and the first shell part 220 define the second space 112. An outer surface defined by the divider 210 and the first shell part 220 and the main housing 100 define the first space 111.

It can be understood that, in this way, the electronic device 400 and the driving unit 500 can be prevented from being damaged by the moist fluid leaked from the fluid pumping component 300, and even if external water flow leaks into the body chamber 110 through the main housing 100, the electronic device 400 and the driving unit 500 may be prevented from being damaged by the leaked moist fluid.

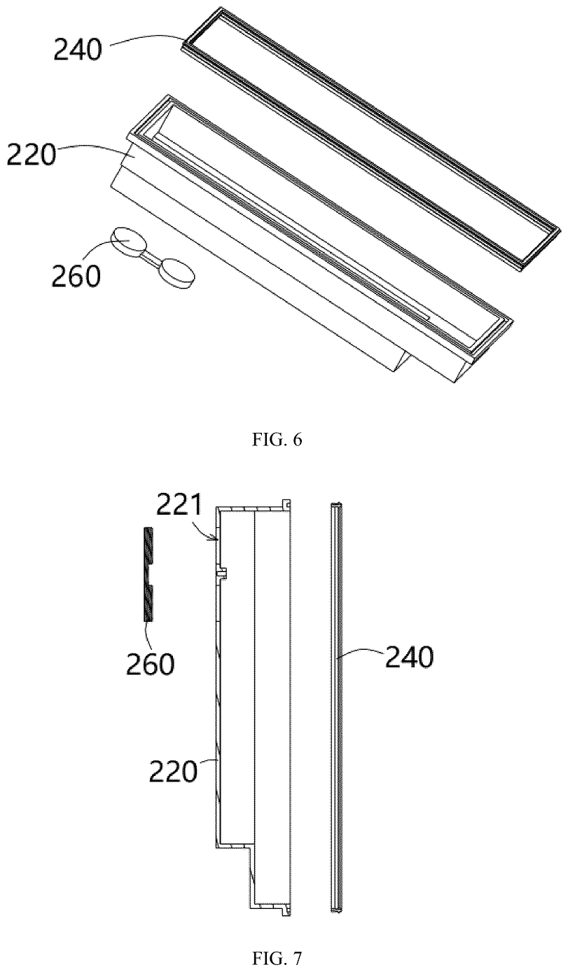

As shown in FIGS. 6 to 8, in an implementable embodiment, an interface of the divider 210 and the first shell part 220 is provided with a first sealing part 240, and a joining gap of the divider 210 and the first shell part 220 is sealed by the first sealing part 240, thereby avoiding that the moist fluid leaked from the fluid pumping component 300 enters the second space 112 through the joining gap of the divider 210 and the first shell part 220 to damage the electronic device 400 and the driving unit 500.

In practical applications, a buckling structure may be arranged around the divider 210 and the first shell part 220, and the divider 210 and the first shell part 220 are mutually buckled and spliced into a whole through the buckling structure; and/or, the divider 210 and the first shell part 220 may be integrally formed by screw locking splicing. The interface of the divider 210 and/or the interface of the first shell part 220 may be provided with a mounting groove, and the first sealing part 240 may be previously mounted in the mounting groove, so that the first sealing part 240 is packed at the joining gap between the divider 210 and the first shell part 220 when the divider 210 and the first shell part 220 are spliced to each other. Certainly, one of the divider 210 and the first shell part 220 may be formed integrally with the first sealing part 240 by means of dual-injection molding, and the other may be in interference connection with the first sealing part 240.

In an optional embodiment, the divider 210 or the first shell part 220 may be provided with a sealed transmission mechanism, the transmission mechanism forms a part of the divider 210 or the first shell part 220 and participates in isolation sealing of the first space 111 and the second space 112, and meanwhile, the transmission mechanism has two ends capable of transmitting power, one end is located in the second space 112 and connected to an output end of the driving unit 500, the other end is located in the first space 111 and connected to the fluid pumping component 300, and the driving unit 500 may drive the fluid pumping component 300 to operate through the transmission mechanism. In this way, the moist fluid in the first space 111 may be prevented from leaking into the second space 112 through a transmission gap between the driving unit 500 and the fluid pumping component 300.

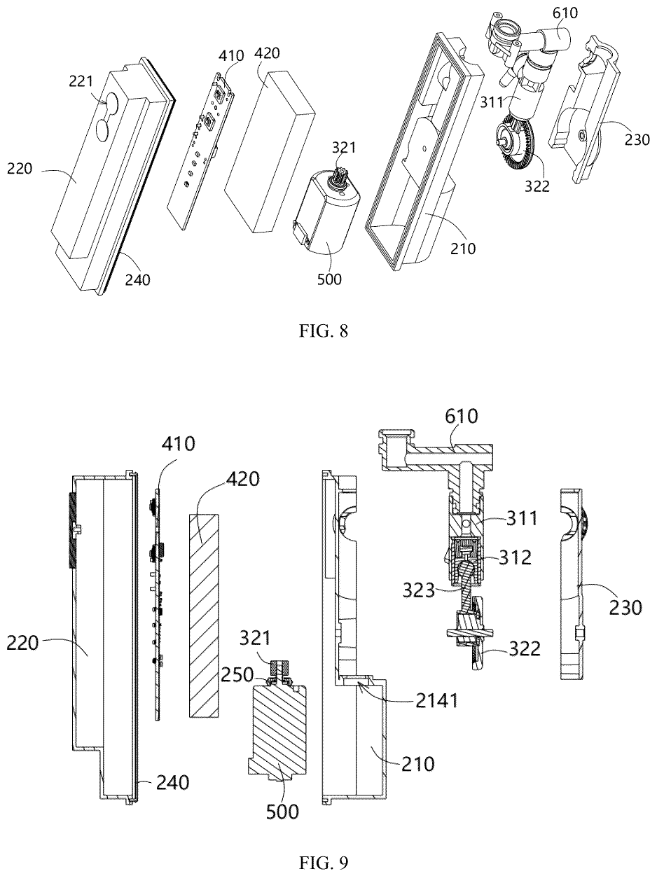

As shown in FIGS. 8 and 9, in another optional embodiment, the divider 210 or the first shell part 220 is provided with a first avoiding hole 2141, the output end of the driving unit 500 passes through the first avoiding hole 2141 to extend into the first space 111, and a second sealing part 250 is packed between the output end and the first avoiding hole 2141. In this way, the moist fluid in the first space 111 may be prevented from leaking into the second space 112 through a gap between the output end of the driving unit 500 and the first avoiding hole 2141.

In practical applications, the second sealing part 250 may be a sealing ring, an outer circumference of the sealing ring is fixed on an inner wall surface of the first avoiding hole 2141, and an inner circumference of the second sealing part 250 sleeves the output end and contacts the output end.

Considering that the main housing 100 of the oral nursing device is also required to be provided with a control key, and the control key needs to be pressed to contact a button on the PCB 410 in the second space 112, the first shell part 220 is also required to be provided with a key hole 221. Correspondingly, the housing component 200 may further include a key sealing part 260, the key sealing part 260 is coupled with the PCB 410, and the key sealing part 260 seals the key hole 221, so as to prevent the moist fluid in the first space 111 from leaking into the second space 112 through the key hole 221.

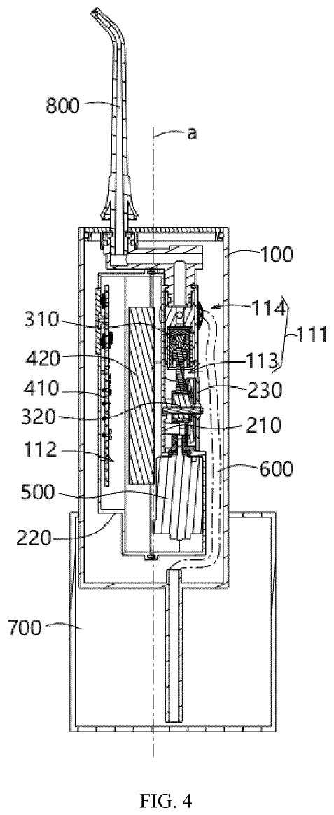

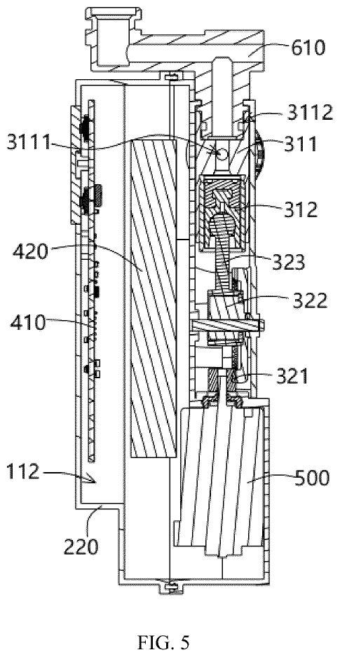

As shown in FIGS. 4 and 5, on the basis of the third embodiment, the housing component 200 may further include a second shell part 230. The second shell part 230 is located in the first space 111, the second shell part 230 is coupled with the divider 210, and the second shell part 230 divides the first space 111 into a third space 113 and a fourth space 114.

The third space 113 is defined by the divider 210 and the second shell part 230, and the fluid pumping component 300 is assembled in the third space 113. The fourth space 114 may be defined by the main housing 100 and an outer surface defined by the divider 210, the first shell part 220 and the second shell part 230, and the flow guide channel 600 is at least partially located in the fourth space 114. In this way, the divider 210, the first shell part 220 and the second shell part 230 may integrate the fluid pumping component 300, the electronic device 400 and the driving unit 500 into a whole, so as to be integrally mounted in the body chamber 110 or detached from the body chamber 110, thereby facilitating disassembling and assembling operations.

In this embodiment, from the perspective of a vertical section of the oral nursing device, the fourth space 114 may be arranged around the second space 112 and/or the fourth space 114 may be arranged around the third space 113, and the housing component 200 formed by the divider 210, the first shell part 220 and the second shell part 230 forms a suspension-like visual effect within the body chamber 110. Moreover, this arrangement can further facilitate communication between the flow guide channel 600 and the fluid source 700 located below, and the flow guide channel 600 can be conveniently arranged.

In practical applications, a buckling structure may be arranged around the divider 210 and the second shell part 230, and the divider 210 and the second shell part 230 are mutually buckled and spliced into a whole through the buckling structure; and/or, the divider 210 and the second shell part 230 may be integrally formed by screw locking splicing.

In an implementable embodiment, a third sealing part (not shown) is provided at an interface of the divider 210 and the second shell part 230, and a sealing gap of the divider 210 and the second shell part 230 is sealed by the third sealing part, so that the moist fluid leaked from the fluid pumping component 300 is confined within the third space 113, and it is avoided that the moist fluid leaked from the fluid pumping component 300 is leaked from the third space 113 into the fourth space 114, and thus leaked out of the main housing 100 or into the second space 112.

In other words, the divider 210 and the second shell part 230 jointly form a housing structure of the fluid pumping component 300, and the fluid pumping component 300 realizes isolated sealing with the divider 210 and the second shell part 230, so as to prevent the fluid leaked from the fluid pumping component 300 from being leaked outwards. In this way, the characteristics that the divider 210 and the second shell part 230 have high strength and are not prone to be damaged may be used, and the divider 210 and the second shell part 230 do not need to move along with a transmission unit 320 in the fluid pumping component 300 and are not prone to generate fatigue damage, thereby ensuring sealing reliability and a sealing life of the fluid pumping component 300.

In practical applications, the interface of the divider 210 and/or the interface of the second shell part 230 may be provided with a mounting groove, and the third sealing part may be previously mounted in the mounting groove, so that the third sealing part is packed at a joining gap between the divider 210 and the second shell part 230 when the divider 210 and the second shell part 230 are spliced to each other. Certainly, one of the divider 210 and the second shell part 230 may be formed integrally with the third sealing part by means of dual-injection molding, and the other may be in interference connection with the third sealing part.

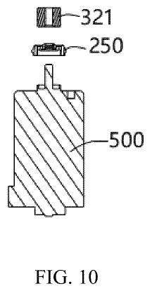

With respect to a specific structure of the fluid pumping component 300, as shown in FIGS. 4, 5, and 8 to 10, in an implementable embodiment, the fluid pumping component 300 may include an execution unit 310 and a transmission unit 320, and the driving unit 500 drives the execution unit 310 to move through the transmission unit 320, so as to draw the fluid in the fluid source 700 and discharge the fluid. The execution unit 310 may take different structures depending on a specific form of the fluid pumping component 300. For example, the execution unit 310 may have a diaphragm structure when the fluid pumping component 300 is a diaphragm pump, and the execution unit 310 may have a piston structure when the fluid pumping component 300 is a piston pump.

As an example, the execution unit 310 has a piston structure, the execution unit 310 may include a pump body 311 and a piston 312, the pump body 311 has a first inlet 3111 and a first outlet 3112, and the piston 312 is slidably arranged in the pump body 311, so that the fluid may be drawn from the first inlet 3111 and discharged from the first outlet 3112 by a reciprocating motion of the piston 312 in the pump body 311.

In practical applications, the pump body 311 may be made of copper, alloy, other metals, or other high-strength materials. The divider 210 and the second shell part 230 may be formed in an injection molding manner using an injection molding part. The pump body 311 may be formed of two parts. Specifically, the pump body 311 includes a pump shell and a cylinder sleeve, the cylinder sleeve is arranged in the pump shell, and the piston 312 is slidably arranged in the cylinder sleeve, so that use requirements can be met only by improving wear resistance of the cylinder sleeve, thereby further lowering machining requirements and reducing a production cost.

Regarding a specific structure of the transmission unit 320, in an implementable embodiment, the transmission unit 320 may include a first gear 321, an end surface eccentric gear 322, and a connecting rod 323. The end surface eccentric gear 322 is rotatably connected with the divider 210 and/or the second shell part 230, and the first gear 321 is connected with the output end of the driving unit 500 and meshed with a gear portion of the end surface eccentric gear 322. An eccentric portion of the end surface eccentric gear 322 is connected with one end of the connecting rod 323, the other end of the connecting rod 323 is connected with the execution unit 310, and when the execution unit 310 has a piston structure, the other end of the connecting rod 323 is connected with the piston 312. When the driving unit 500 drives the first gear 321 to rotate, the first gear 321 can drive the eccentric portion of the end surface eccentric gear 322 to perform an eccentric motion, and the eccentric motion is converted into a linear motion through the connecting rod 323, so as to drive the piston 312 to perform a linear reciprocating motion.

The eccentric portion of the end surface eccentric gear 322, the connecting rod 323, and the first gear 321 may be located on two opposite sides of the gear portion of the end surface eccentric gear 322.

The first gear 321, the eccentric portion of the end surface eccentric gear 322 and the connecting rod 323 can also be located on the same side of the gear portion of the end surface eccentric gear 322, and the first gear 321, the eccentric portion of the end surface eccentric gear 322 and the connecting rod 323 share the same thickness space, so that an overall thickness of the fluid pumping component 300 can be reduced, and the main housing 100 can be made thin, thereby facilitating a holding operation of a user.

As shown in FIG. 4, in an implementable embodiment, the main housing 100 has a main extension line a, and the driving unit 500, the transmission unit 320, and the execution unit 310 are arranged along the main extension line a. In this way, a main extension direction of the fluid pumping component 300 can be coincident with a main extension direction of the main housing 100, a shape of the main housing 100 is fully utilized to arrange the fluid pumping component 300, and the problem that the main housing 100 needs to be made oversize to affect the holding operation of the user is avoided. Meanwhile, with this arrangement design, a sufficient space can be reserved between a side surface of the fluid pumping component 300 and the main housings 100 to accommodate the electronic device 400. That is, the electronic device 400 and the fluid pumping component 300 are arranged in a direction perpendicular to the main extension line a, so that an overall length of the oral nursing device can be shortened, and carrying is facilitated.

In an implementable embodiment, a piston sealing ring may be connected to the piston 312, the piston sealing ring is configured to block the moist fluid in the pump body 311 from leaking through a gap between the piston 312 and the cylinder sleeve, and an O-ring sleeves the cylinder sleeve and is configured to block the moist fluid in the pump body 311 from leaking through a gap between the cylinder sleeve and an inner wall surface of an integral body formed by the divider 210 and the second shell part 230, so that the possibility of liquid leakage is further reduced.

Furthermore, it may be understood that the sealing arrangement of the piston sealing ring and the O-ring can also divide the third space 113 into an execution cavity and a transmission cavity which are hermetically isolated from each other, the transmission unit 320 is arranged in the transmission cavity, and the execution unit 310 is arranged in the execution cavity. In order to further reduce a hazard of leakage of the moist fluid, the divider 210 and/or the second shell part 230 may be provided with a communication hole communicated with the transmission cavity, and the communication hole is communicated with the external environment through a flow guide pipe. Therefore, when the moist fluid in the execution cavity leaks into the transmission cavity, the moist fluid can flow into the external environment through the flow guide pipe, thereby avoiding that the moist fluid is retained in the transmission cavity for a long time and damages a corresponding sealing structure, and then avoiding the possibility that the moist fluid leaks out of the third space 113.

The oral nursing device according to the present application may be an oral irrigator, an irrigation-brushing all-in-one machine, or the like. Taking the oral nursing device as the irrigation-brushing all-in-one machine as an example, the oral nursing device can further include a brush head and a motor, wherein the brush head is provided with a conveying flow channel, as well as a communication port and a liquid spraying port which are located at two ends of the conveying flow channel, and brush bristles are arranged on the brush head and located at an end of the brush head provided with the liquid spraying port. The motor has a power output shaft and is connected with the brush head through the power output shaft, so as to drive the brush head to perform a cleaning motion. The power output shaft is constructed as a hollow shaft, and the first outlet 3112 of the fluid pumping component 300 is communicated with the conveying flow channel in the brush head through the power output shaft, so that the fluid pumped by the fluid pumping component 300 can sequentially pass through the power output shaft and the conveying flow channel, and finally, a water flow impact is output from the liquid spraying port.

Taking the oral nursing device as the oral irrigator as an example, the oral nursing device further includes a liquid guide connector 610 and a nozzle head 800, the first inlet 3111 of the fluid pumping component 300 is communicated with the fluid source 700 through the flow guide channel 600, and the first outlet 3112 of the fluid pumping component 300 is communicated with the nozzle head 800 through the liquid guide connector 610.

Based on the same inventive concept, the present application further provides a fluid pumping assembly for oral cleaning, including: a divider 210, a first shell part 220, a second shell part 230, a fluid pumping component 300, an electronic device 400 and a driving unit 500, wherein the first shell part 220 and the second shell part 230 are located on two opposite sides of the divider 210 respectively, the first shell part 220 and the divider 210 define a third space 113, the second shell part 230 and the divider 210 define a first space 111, the fluid pumping component 300 is assembled in the first space 111, and the electronic device 400 and the driving unit 500 are assembled in the third space 113.

For specific structures of the divider 210, the first shell part 220, the second shell part 230, and the fluid pumping component 300, reference may be made to the detailed descriptions in the above embodiments, and details are not repeated herein.

According to the technical solution provided by the present application, the body cavity is divided by the housing component into the first space and the second space which are hermetically isolated from each other, the fluid pumping component is arranged in the first space, and the electronic device and the driving unit are arranged in the second space. That is, the fluid pumping component which possibly leaks moist fluid, and the electronic device and the driving unit which are easily damaged by the moist fluid are respectively mounted in the two spaces which are hermetically isolated from each other, and dry-wet separation is performed. In this way, even when the fluid pumping component leaks the moist fluid, it is avoid that the moist fluid enters the second space through the first space to damage the electronic device and the driving unit, and the service life of the oral nursing device is prolonged.

The terms “upper”, “lower”, or the like, are used for describing relative position relationships of structures in the drawings, are used only for clarity of description, and are not intended to limit the scope of implementation of the present application, and changes or adjustments of the relative relationships, without substantial alteration of the technical content, should also be regarded as within the scope of implementation of the present application.

It should be noted that, in the present application, unless specified or limited otherwise, a structure in which a first feature is “on” or “below” a second feature may include an embodiment in which the first feature is in direct contact with the second feature, and may also include an embodiment in which the first feature and the second feature are contacted via an additional feature formed therebetween. Furthermore, a first feature “on”, “above” and “over” a second feature may be directly on or obliquely above the second feature, or simply mean that the first feature is at a higher level than the second feature. A first feature “under”, “below” and “beneath” a second feature may be directly under or obliquely below the second feature, or simply mean that the first feature is at a lower level than the second feature.

Furthermore, in the present application, unless specified or limited otherwise, the terms “mounted”, “connected”, “coupled”, and “fixed” and the like are used broadly, and may be, for example, fixed connections, detachable connections, or integral connections; may also be direct connections or indirect connections via intervening structures; may also be communication or an interaction relationship of two elements. The above terms can be understood by those skilled in the art according to specific situations.

In the description of the specification, references to “an embodiment”, “some embodiments”, “exemplary embodiments”, “examples”, “specific examples”, “some examples”, or the like, mean that a particular feature, structure, material, or characteristic described in connection with the embodiment or example is included in at least one embodiment or example of the present disclosure. In this specification, schematic depictions of the above terms do not necessarily refer to the same embodiment or example. Furthermore, the described particular features, structures, materials, or characteristics may be combined in any suitable manner in one or more embodiments or examples.

Finally, it should be noted that the above embodiments are only used to illustrate the technical solutions of the present application, not to limit the present application; although the present application is described in detail with reference to the above embodiments, those having ordinary skill in the art should understand that they still can modify technical solutions recited in the aforesaid embodiments or equivalently replace partial or all technical features therein; these modifications or substitutions do not make essence of corresponding technical solutions depart from the scope of technical solutions of embodiments of the present application.

What is claimed is:

1. An oral nursing device, at least comprising:
a main housing (100) having an outer wall and a body chamber (110) defined by the outer wall;
a housing component (200) arranged in the body chamber (110) and dividing the body chamber (110) into at least a first space (111) and a second space (112) which are hermetically isolated from each other;
a fluid pumping component (300) assembled in the first space (111), the fluid pumping component (300) being in communication with a fluid source (700) through a flow guide channel (600); and
an electronic device (400) and a driving unit (500) assembled in the second space (112), the driving unit (500) driving the fluid pumping component (300) to run to draw fluid in the fluid source (700) through the flow guide channel (600) and output a water flow impact.

2. The oral nursing device according to claim 1, wherein the housing component (200) comprises a divider (210), and the divider (210) is coupled with an inner wall surface of the main housing (100) to divide the body chamber (110) into the first space (111) and the second space (112).

3. The oral nursing device according to claim 1, wherein the housing component (200) comprises a divider (210) and a first shell part (220), and the divider (210) and the first shell part (220) define the second space (112).

4. The oral nursing device according to claim 3, wherein an interface of the divider (210) and the first shell part (220) is provided with a first sealing part (240).

5. The oral nursing device according to claim 4, wherein one of the divider (210) and the first shell part (220) is formed integrally with the first sealing part (240) by means of dual-injection molding, and the other is in interference fit with the first sealing part (240).

6. The oral nursing device according to claim 3, wherein the divider (210) or the first shell part (220) is provided with a first avoiding hole (2141), an output end of the driving unit (500) passes through the first avoiding hole (2141) to extend to the first space (111), and a second sealing part (250) is packed between the output end and the first avoiding hole (2141).

7. The oral nursing device according to claim 3, wherein a key hole (221) is arranged in the first shell part (220);
the electronic device (400) comprises a PCB (410), the housing component (200) further comprises a key sealing part (260) coupled with the PCB (410), and the key sealing part (260) seals the key hole (221).

8. The oral nursing device according to claim 3, wherein an outer surface defined by the divider (210) and the first shell part (220) and the main housing (100) define the first space (111).

9. The oral nursing device according to claim 8, wherein the housing component (200) further comprises a second shell part (230) located within the first space (111);
the second shell part (230) is coupled with the divider (210) to divide the first space (111) into a third space (113) and a fourth space (114), the third space (113) is defined by the divider (210) and the second shell part (230), and the fluid pumping component (300) is assembled in the third space (113).

10. The oral nursing device according to claim 9, wherein the fourth space (114) is defined by the main housing (100) and an outer surface defined by the divider (210), the first shell part (220) and the second shell part (230), and the flow guide channel (600) is at least partially located in the fourth space (114).

11. The oral nursing device according to claim 9, wherein the fourth space (114) is arranged around the second space (112), and/or the fourth space (114) is arranged around the third space (113).

12. The oral nursing device according to claim 9, wherein a third sealing part is arranged at an interface of the divider (210) and the second shell part (230).

13. The oral nursing device according to claim 1, wherein the fluid pumping component (300) comprises an execution unit (310) and a transmission unit (320),
the execution unit (310) comprises a pump body (311) and a piston (312), the pump body (311) has a first inlet (3111) and a first outlet (3112), and the piston (312) is slidably arranged in the pump body (311).

14. The oral nursing device according to claim 13, wherein the transmission unit (320) comprises a first gear (321), an end surface eccentric gear (322) and a connecting rod (323);
the first gear (321) is connected with the output end of the driving unit (500) and meshed with a gear portion of the end surface eccentric gear (322);
one end of the connecting rod (323) is connected with an eccentric portion of the end surface eccentric gear (322), the other end of the connecting rod (323) is connected with the piston (312), and the first gear (321), the eccentric portion of the end surface eccentric gear (322) and the connecting rod (323) are located on the same side of the gear portion of the end surface eccentric gear (322).

15. The oral nursing device according to claim 13, wherein the main housing (100) has a main extension line (a);
the driving unit (500), the transmission unit (320) and the execution unit (310) are arranged along the main extension line (a), and the electronic device (400) and the fluid pumping component (300) are arranged along a direction perpendicular to the main extension line (a).

16. The oral nursing device according to claim 1, wherein the housing component (200) comprises a divider (210) and a second shell part (230);
the divider (210) and the second shell part (230) define the first space (111), and an outer surface defined by the divider (210) and the second shell part (230) and the main housing (100) define the second space (112).

17. The oral nursing device according to claim 1, further comprising a liquid guide connector (610) and a nozzle head (800),
wherein the first inlet (3111) of the fluid pumping component (300) is in communication with the fluid source (700) through the flow guide channel (600), and the first outlet (3112) of the fluid pumping component (300) is in communication with the nozzle head (800) through the liquid guide connector (610).

18. The oral nursing device according to claim 1, further comprising a brush head and a motor,
wherein the motor has a power output shaft, the motor drives the brush head to perform a cleaning motion through the power output shaft, the power output shaft is a hollow shaft, and the first outlet (3112) of the fluid pumping component (300) is communicated with a conveying flow channel in the brush head through the power output shaft.

19. A fluid pumping assembly for oral cleaning, comprising: a divider (210), a first shell part (220), a second shell part (230), a fluid pumping component (300), an electronic device (400) and a driving unit (500),
wherein the first shell part (220) and the second shell part (230) are located on two opposite sides of the divider (210) respectively, the first shell part (220) and the divider (210) define a third space (113), the second shell part (230) and the divider (210) define a first space (111), the fluid pumping component (300) is assembled in the first space (111), and the electronic device (400) and the driving unit (500) are assembled in the third space (113).
